(19) United States
(12) Patent Application Publication
(10) Pub. No.: US 2023/0116529 A1
(43) Pub. Date: Apr. 13, 2023

(54) PROCESS FOR PREPARING ORGANO-TITANIUM COMPOUNDS

(71) Applicant: ENTEGRIS, INC., Bilerica, MA (US)

(72) Inventors: Vagulejan Balasanthiran, Horsham, PA (US); Scott A. Laneman, Vernon Hills, IL (US); Sharon Kirk, Philadelphia, PA (US)

(21) Appl. No.: 17/957,835

(22) Filed: Sep. 30, 2022

Related U.S. Application Data
(60) Provisional application No. 63/253,752, filed on Oct. 8, 2021.

(51) Int. Cl. C07F 17/00

(52) U.S. Cl. CPC C07F 17/00

(57) ABSTRACT

The disclosure provides a facile process for preparing certain half-sandwich titanocene compounds. The compounds are useful in catalyst systems for polyolefin synthesis. In one embodiment, highly-pure trimethyl(pentamethylcyclopentadienyl)titanium (IV) is produced from the reaction of trichloro(pentamethylcyclopentadienyl)titanium (IV) with a methyl magnesium halide compound.

### CROSS-REFERENCE TO RELATED APPLICATIONS

This application claims the benefit under 35 USC 119 of U.S. Provisional Patent Application No. 63/253,752, filed Oct. 8, 2021, the disclosure of which is hereby incorporated herein by reference in its entirety.

### TECHNICAL FIELD

The disclosure generally belongs to the field of organometallic synthesis. In particular, it relates to a process for preparing certain organo-titanium compounds.

### BACKGROUND

Titanium (IV) compounds having one or two cyclopentadiene groups associated therewith are useful in catalyst systems for the synthesis of polyolefins. In particular, half-sandwich titanocene catalysts such as the compound trimethyl(pentamethylcyclo-pentadienyl)titanium(IV), CAS No. 107333-47-1, is of particular interest. It can be prepared in high yield by reacting the corresponding trichloro compound with methyl lithium. However, the pyrophoric methyl lithium reagent requires very low temperatures and provides a product which has undesired lithium content. Accordingly, an improved process for preparing such organo-titanium (IV) compounds would be of great interest.

### SUMMARY

In summary, the disclosure provides a process for preparing a compound of the Formula

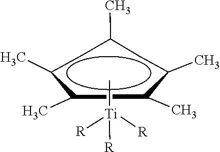

wherein R is chosen from methyl, ethyl, n-propyl, n-butyl, and isobutyl, which comprises contacting a compound of the Formula (A):

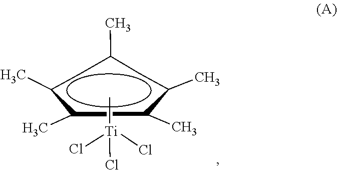

with a compound of the formula RMgX or (R)₂Mg, wherein X is chosen from chloro, bromo, and iodo.

Also provided are highly pure forms of the products of Formula (I), in particular trimethyl(pentamethylcyclo-pentadienyl)titanium(IV).

### DETAILED DESCRIPTION

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise.

The term “about” generally refers to a range of numbers that is considered equivalent to the recited value (e.g., having the same function or result). In many instances, the term “about” may include numbers that are rounded to the nearest significant figure.

Numerical ranges expressed using endpoints include all numbers subsumed within that range (e.g., 1 to 5 includes 1, 1.5, 2, 2.75, 3, 3.80, 4 and 5).

In a first aspect, the disclosure provides a process for preparing a compound of the Formula (I):

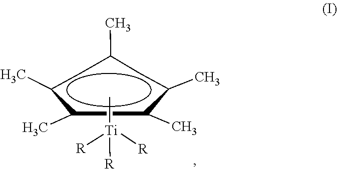

wherein R is chosen from methyl, ethyl, n-propyl, n-butyl, isobutyl, and benzyl, which comprises contacting a compound of the Formula (A):

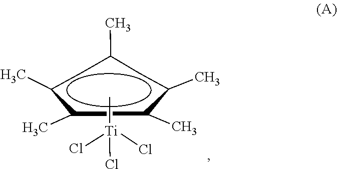

with a compound of the formula RMgX or (R)₂Mg, wherein X is chosen from chloro, bromo, and iodo.

In this process, each R can be the same or different; exemplary R groups include wherein R is chosen from methyl, ethyl, n-propyl, n-butyl, isobutyl, and benzyl,

In one embodiment, each R is methyl.

The reagent of the formula RMgX is generally prepared in an ether solvent such as diethyl ether or tetrahydrofuran (THF), and then added to a solution of the starting material of the Formula (A) in an aprotic non-polar solvent such as hexanes. The process can be conducted at room temperature. Workup involves filtration of the by-product of the formula MgX₂, followed by removal of solvents in vacuo. Recrystallization of the resulting solid material in a non-coordinating solvent such as hexanes, pentanes, heptanes, and toluene, can afford the desired product of Formula (I) in a more pure form.

Reagents of the formula (R)₂Mg can be prepared by known methodology. For example, the method taught in U.S. Pat. No. 3,737,393, incorporated herein by reference in its entirety for all purposes.

The process of the present disclosure thus provides an improved process for preparing compounds of the Formula (I), in high yield and in exceptional purity. Overall, the purity of the resulting reaction product is generally at least about 95.0, at least about 96.0, at least about 97.0, at least about 98.0, or at least about 99.0 percent or more of the desired compound of the Formula (I) and less than about 600 ppm, less than about 500 ppm, less than about 400, less than about 300, less than about 200, less than about 100, or less than about 50 ppm of magnesium. Additionally, unlike processes utilizing alkyl lithium reagents, the products of the process possess only background levels of lithium, i.e., less than about 100, less than about 10, or less than about 1 ppm. The crystalline products of Formula (I) can be recrystallized to contain no more than about 25 ppm of magnesium, i.e., less than 26 ppm of magnesium. In certain embodiments, the reaction product comprising the compound of Formula (I) possesses less than about 1 ppm of lithium and less than about 26 ppm of magnesium. In one embodiment, the compound of Formula (I) wherein each R is methyl is produced in these levels of purity.

In one embodiment, the compound of Formula (I) is trimethyl(pentamethylcyclo-pentadienyl)titanium(IV), CAS No. 107333-47-1. In general, the compounds of Formula (I) are useful in the synthesis of a class of polyolefin catalysts known generally as half-sandwich titanocenes.

### EXAMPLES

### Example 1—Synthesis of Cp*TiMe₃ from methylmagnesium bromide (MeMgBr)

MeMgBr [3 M in ether, 34.5 mL, 103.6 mmol] was added dropwise to a stirred solution of Cp*TiCl₃ [10.0 g, 34.5 mmol] in 100 mL hexanes between 0-5° C. in a Schlenk flask under nitrogen atmosphere. After the addition the reaction mixture was allowed to warm to room temperature. Then the solution was stirred for 12 h at room temperature. The 3 M MeMgBr solution in ether can be added dropwise at room temperature and this will not affect the reaction outcome. All the volatiles were removed under vacuum. The resulting crude mixture was dissolved in hexanes and cannulated to second Schlenk flask under nitrogen pressure. Hexanes were evaporated under vacuum to yield a pale-yellow solid. The resulting pale-yellow solid was analyzed by ¹H-NMR. Purity (by NMR integration) ˜99.1% and overall yield of 7.4 g (94%). (Cp* denotes pentamethylcyclopentadiene.)

Note: The reaction can also be performed in tetrahydrofuran (THF) instead of hexanes. During the addition of MeMgBr, the Cp*TiCl₃ in THF solution needed to maintain 0-5° C. The reaction completed in one hour.

¹H-NMR (C₆D₆, δ-ppm): 1.75 (s, 15H, CpMe) and 0.99 (s, 9H, Ti-Me)

Mg content: 480 ppm

Recrystallization: Recrystallization of Cp*TiMe₃ from hexanes reduced the Mg content from 480 ppm to 25 ppm and the lithium content to less than 1 ppm. (As determined by ICP-OES (Inductively Coupled Plasma Optical Emission Spectrometry)).

### Example 2—Synthesis of Cp*TiMe₃ from Methylmagnesium Chloride (MeMgCl)

MeMgCl [3 M in THF, 34.5 mL, 103.6 mmol] was added dropwise to a stirred solution of Cp*TiCl₃ [10.0 g, 34.5 mmol] in 100 mL hexanes between 0-5° C. in a Schlenk flask under nitrogen atmosphere. After the addition the reaction mixture was allowed to warm to room temperature. The solution was stirred for 3 h at room temperature. All the volatiles were removed under vacuum. The resulting crude mixture was dissolved in hexanes and cannulated to a second Schlenk flask under nitrogen pressure. Hexanes evaporated under vacuum to yield a pale-yellow solid. The resulting pale-yellow solid was analyzed by ¹H-NMR. Purity (by NMR integration) ˜98.8% and overall yield of 6.2 g (78.6%).

Note: The reaction can also be performed in THF instead of Hexanes.

¹H-NMR (C₆D₆, δ-ppm): 1.75 (s, 15H, CpMe) and 0.99 (s, 9H, Ti-Me)

### Example 3—Synthesis of Cp*TiMe₃ from Methylmagnesium Iodide (MeMgI)

MeMgI [3 M in diethyl ether, 34.5 mL, 103.6 mmol] was added dropwise to a stirred solution of Cp*TiCl₃ [10.0 g, 34.5 mmol] in 100 mL hexanes between 0-5° C. in a Schlenk flask under nitrogen atmosphere. After the addition the reaction mixture was allowed to warm to room temperature. The solution was stirred for 12 h at room temperature. All the volatiles were removed under vacuum. The resulting crude mixture was dissolved in hexanes and cannulated to a second Schlenk flask under nitrogen pressure. Hexanes were evaporated under vacuum to yield a pale-yellow solid. The resulting pale-yellow solid was analyzed by ¹H-NMR. Purity (by NMR integration) ˜98.2% and overall yield of 4.7 g (60%).

Note: The reaction can also be performed in THF instead of Hexanes.

¹H-NMR (C₆D₆, δ-ppm): 1.75 (s, 15H, CpMe) and 0.99 (s, 9H, Ti-Me)

Aspects

In a first aspect, the disclosure provides a process for preparing a compound of the Formula (I):

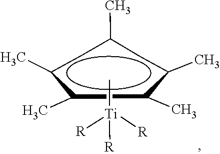

wherein R is chosen from methyl, ethyl, n-propyl, n-butyl, isobutyl, and benzyl, which comprises contacting a compound of the Formula (A):

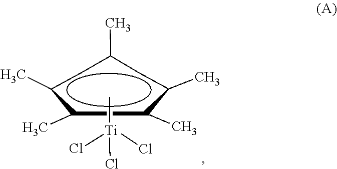

with a compound of the formula RMgX wherein X is chosen from chloro, bromo, and iodo.

In a second aspect, the disclosure provides the process of the first aspect, wherein X is chloro.

In a third aspect, the disclosure provides the process of the first aspect, wherein X is bromo.

In a fourth aspect, the disclosure provides the process of the first aspect, wherein X is iodo.

In a fifth aspect, the disclosure provides the process of any of the first through fourth aspects, wherein R is methyl.

In a sixth aspect, the disclosure provides the process of any of the first through fourth aspects, wherein R is ethyl.

In a seventh aspect, the disclosure provides the process of any of the first through fourth aspects, wherein R is n-propyl.

In an eighth aspect, the disclosure provides the process of any of the first through fourth aspects, wherein R is n-butyl.

In a ninth aspect, the disclosure provides the process of any of the first through fourth aspects, wherein R is isobutyl.

In a tenth aspect, the disclosure provides the process of any of the first through fourth aspects, wherein R is benzyl.

In an eleventh aspect, the disclosure provides a process for preparing a compound of the Formula (I):

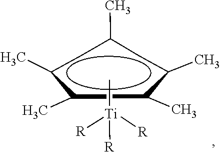

wherein R is chosen from methyl, ethyl, n-propyl, n-butyl, isobutyl, and benzyl, which comprises contacting a compound of the Formula (A):

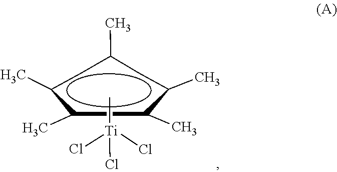

with a compound of the formula (R)₂Mg wherein X is chosen from chloro, bromo, and iodo.

In a twelfth aspect, the disclosure provides the process of the first aspect, wherein X is chloro.

In a thirteenth aspect, the disclosure provides the process of the first aspect, wherein X is bromo.

In a fourteenth aspect, the disclosure provides the process of the first aspect, wherein X is iodo.

In a fifteenth aspect, the disclosure provides the process of any of the eleventh through fourteenth aspects, wherein R is methyl.

In a sixteenth aspect, the disclosure provides the process of any of the eleventh through fourteenth aspects, wherein R is ethyl.

In a seventeenth aspect, the disclosure provides the process of any of the eleventh through fourteenth aspects, wherein R is n-propyl.

In an eighteenth aspect, the disclosure provides the process of any of the eleventh through fourteenth aspects, wherein R is n-butyl.

In a nineteenth aspect, the disclosure provides the process of any of the eleventh through fourteenth aspects, wherein R is isobutyl.

In a twentieth aspect, the disclosure provides the process of any of the eleventh through fourteenth aspects, wherein R is benzyl.

In a twenty-first aspect, the disclosure provides a composition comprising at least 95.0 weight percent of a compound of the formula

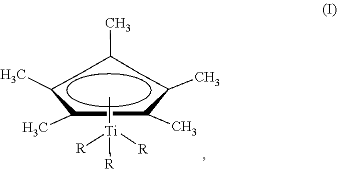

wherein R is chosen from methyl, ethyl, n-propyl, n-butyl, isobutyl, and benzyl, and wherein the composition comprises less than about 100 ppm of lithium.

In a twenty-second, the disclosure provides the composition of the twenty-first aspect, wherein the composition further comprises less than about 600 ppm of magnesium.

In a twenty-third aspect, the disclosure provides the composition of the twenty-first aspect, wherein the composition further comprises less than about 10 ppm of lithium and less than about 100 ppm of magnesium.

In a twenty-fourth aspect, the disclosure provides the composition of the thirteenth aspect, wherein the composition further comprises less than about 1 ppm of lithium and less than about 26 ppm of magnesium.

In a twenty-fifth aspect, the disclosure provides the composition of any of the twenty-first through twenty-fourth aspects, wherein R is methyl.

In a twenty-sixth aspect, the disclosure provides the composition of any of the twenty-first through twenty-fourth aspects, wherein R is ethyl.

In a twenty-seventh aspect, the disclosure provides the composition of any of the twenty-first through twenty-fourth aspects, wherein R is n-propyl.

In a twenty-eighth aspect, the disclosure provides the composition of any of the twenty-first through twenty-fourth aspects, wherein R is n-butyl.

In a twenty-ninth aspect, the disclosure provides the composition of any of the twenty-first through twenty-fourth aspects, wherein R is isobutyl.

In a thirtieth aspect, the disclosure provides composition of any of the twenty-first through twenty-fourth aspects, wherein R is benzyl.

Having thus described several illustrative embodiments of the present disclosure, those of skill in the art will readily appreciate that yet other embodiments may be made and used within the scope of the claims hereto attached. Numerous advantages of the disclosure covered by this document have been set forth in the foregoing description. It will be understood, however, that this disclosure is, in many respects, only illustrative. The disclosure's scope is, of course, defined in the language in which the appended claims are expressed.

What is claimed is:

1. A process for preparing a compound of the Formula (I): 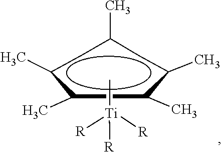
wherein R is chosen from methyl, ethyl, n-propyl, n-butyl, and isobutyl, which comprises contacting a compound of the Formula (A): 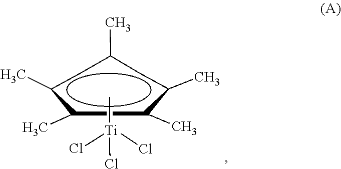
with a compound of the formula RMgX wherein X is chosen from chloro, bromo, and iodo.

2. The process of claim 1, wherein X is chloro.

3. The process of claim 1, wherein X is bromo.

4. The process of claim 1, wherein X is iodo.

5. The process of claim 1, wherein R is methyl.

6. The process of claim 1, wherein R is ethyl.

7. The process of claim 1, wherein R is n-propyl.

8. The process of claim 1, wherein R is n-butyl.

9. The process of claim 1, wherein R is isobutyl.

10. A process for preparing a compound of the Formula (I): 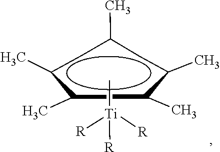
wherein R is chosen from methyl, ethyl, n-propyl, n-butyl, and isobutyl, which comprises contacting a compound of the Formula (A): 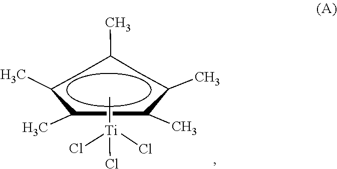
with a compound of the formula (R)₂Mg wherein X is chosen from chloro, bromo, and iodo.

11. The process of claim 10, wherein X is chloro.

12. The process of claim 10, wherein X is bromo.

13. The process of claim 10, wherein X is iodo.

14. The process of claim 10, wherein R is methyl.

15. The process of claim 10, wherein R is ethyl.

16. The process of claim 10, wherein R is n-propyl.

17. The process of claim 10, wherein R is n-butyl.

18. The process of claim 10, wherein R is isobutyl.

19. A composition comprising at least 95.0 weight percent of a compound of the formula 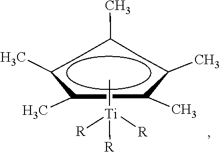
wherein R is chosen from methyl, ethyl, n-propyl, n-butyl, and isobutyl, and wherein the composition comprises less than about 100 ppm of lithium.

20. The composition of claim 19, wherein the composition further comprises less than about 600 ppm of magnesium.

21. The composition of claim 19, wherein the composition further comprises less than about 10 ppm of lithium and less than about 100 ppm of magnesium.

22. The composition of claim 19, wherein the composition further comprises less than about 1 ppm of lithium and less than about 26 ppm of magnesium.

23. The composition of claim 19, wherein R is methyl.

24. The composition of claim 19, wherein R is ethyl.

25. The composition of claim 19, wherein R is n-propyl.

26. The composition of claim 19, wherein R is n-butyl.

27. The composition of claim 19, wherein R is isobutyl.
